(19) United States
(12) Patent Application Publication
(10) Pub. No.: US 2010/0096470 A1
(43) Pub. Date: Apr. 22, 2010

(54) DROP VOLUME REDUCTION

(75) Inventor: Van Nguyen Truskett, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/579,459

(22) Filed: Oct. 15, 2009

Related U.S. Application Data
(60) Provisional application No. 61/106,180, filed on Oct. 17, 2008.

(51) Int. Cl. B05B 17/04

(52) U.S. Cl. 239/11

(57) ABSTRACT

Droplet volume on a substrate may be controlled using a capillary liquid bridge. Generally, droplets may be dispensed in a drop pattern on the substrate. A DV-substrate may be positioned in contact with the droplets and at a distance from the substrate forming a capillary liquid bridge. Separation of the DV-substrate disrupts the capillary liquid bridge with at least a portion of the droplet volume being transferred to the DV-substrate.

### CROSS-REFERENCE TO RELATED APPLICATIONS

This application claims the benefit under 35 U.S.C. §119(e)(1) of U.S. Provisional Patent Application No. 61/106,180, filed Oct. 17, 2008, which is hereby incorporated by reference herein in its entirety.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent, includes formation of a relief pattern in a polymerizable layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of one embodiment of a lithographic system in accordance with the present invention.

FIG. 2 Illustrates a simplified side view of the substrate shown in FIG. 1 having a patterned layer positioned thereon.

FIG. 3 illustrates a simplified side view of an exemplary fluid dispense system.

FIG. 4 illustrates simplified side views of an exemplary substrate undergoing drop volume reduction.

FIG. 5 illustrates a flow chart of an exemplary method for reducing drop volume of polymerizable material positioned on a substrate.

### DETAILED DESCRIPTION

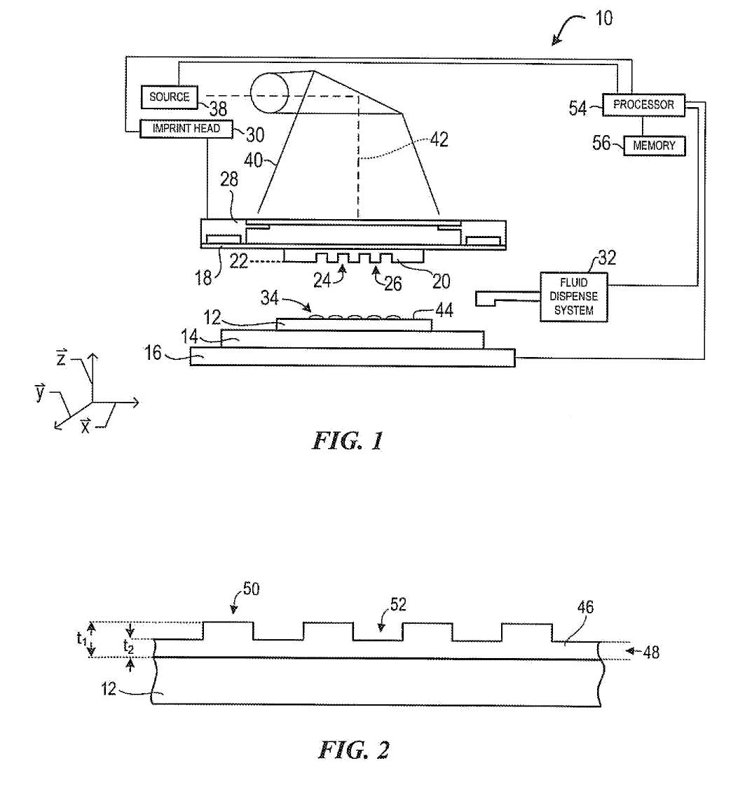

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 22 and substrate 12 depending on design considerations. Polymerizable material 34 may comprise a monomer as described in U.S. Pat. No. 7,157,036 and U.S. Patent Publication No. 2005/0187339, all of which are hereby incorporated by reference.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Pat. No. 7.077,992, U.S. Pat. No. 7,179,396, and U.S. Pat. No. 7,396,475, all of which are hereby incorporated by reference in their entirety.

As described above, polymerizable material 34 may be applied to the defined volume between template 18 and substrate 12 using a fluid dispense system 32. Exemplary fluid dispense systems 32 may include, but are not limited to, a printhead, a microjet tube, syringe, or similar systems that are able to eject a drop of fluid (e.g., =50 picoliters of fluid). For example, fluid dispense system 32 may be a piezo-actuated dispenser commercially available from MicroFab Technologies, Inc., located in Plano, Tex.

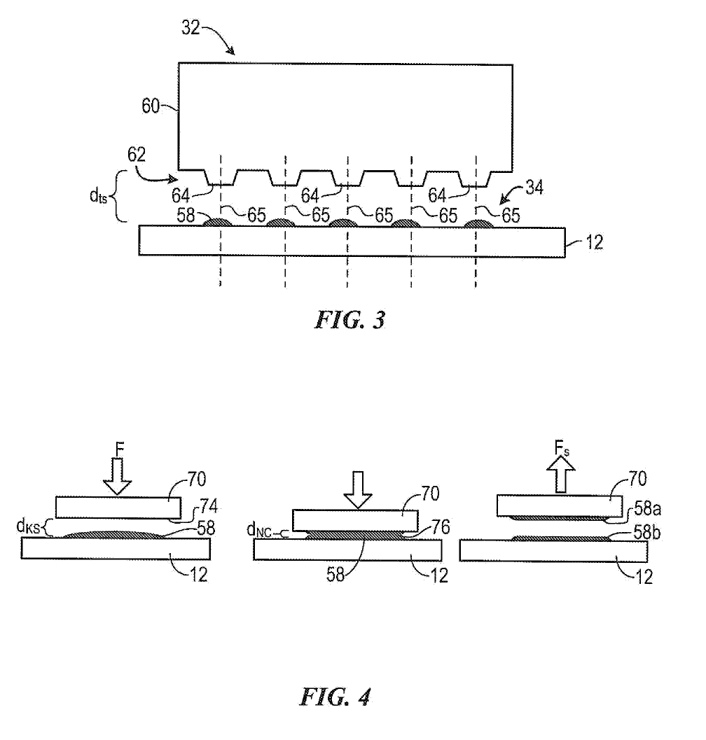

FIG. 3 illustrates an exemplary embodiment of fluid dispense system 32 providing droplets 58 on substrate 12. As illustrated in FIG. 3, droplets 58 may be of polymerizable material 34, however, embodiments of the present invention are not limited to polymerizable material 34 and may include other fluids including, but not limited to, biomaterials, solar cell materials, and/or the like.

Fluid dispense system 32 may comprise a dispense head 60 and nozzle system 62. Nozzle system 62 may comprise a single tip 64 or a plurality of tips 64 depending on design considerations. For example, FIG. 3 illustrates nozzle system 62 comprising a plurality of tips 64. Tip 64 defines a dispensing axis 65 at which droplets 58 of fluid (e.g., polymerizable material 34) may be deposited on substrate 12. The distance dₜₛ between tip 64 and substrate 12 may be selected to reduce and/or avoid splashing of fluid, minimize and/or prevent gas from being present in dispensed fluid (e.g., droplets 58 of polymerizable material 34), and/or to provide for other similar design considerations. For example, distance dₜₛ between tip 64 and substrate 12 may be approximately 500 microns.

Volume of droplet 58 on substrate 12 may be controlled. For example, volume of droplet 58 positioned on substrate 12 may be reduced. FIG. 4 illustrates side views of an exemplary DV-substrate 70 for reducing the volume of droplet 58 positioned on substrate 12. Generally, contact between DV-substrate 70 and droplet 58 on substrate 12 may form a capillary liquid bridge 76 between DV-substrate 70 and substrate 12. Disruption of the capillary liquid bridge 76 may cause droplet 58 to separate into reduced volume droplets 58a and 58b. Further, reduced volume droplets 58a and 58b may be referred to as RV-droplets 58a and 58b respectively. RV droplets 58a and 58b generally each have a reduced volume as compared to droplet 58. Additionally, volume of droplet 58 may be substantially equal to volumes of RV droplets 58a and 58b combined.

DV-substrate 70 may be formed of materials including, but not limited to, fused-silica, quartz, silicon, organic polymers, siloxane polymers, borosilicate glass, fluorocarbon polymers, metal, hardened sapphire, and/or the like. Selection of material for DV-substrate 70 may alter volume of reduced volume droplets 58a and 58b. For example, selection of material for DV-substrate 70 that may be hydrophobic as compared to substrate 12 may reduce volume of RV droplet 58a attaching to DV-substrate 70 while increasing volume of RV droplet 58b attaching to substrate 12 upon disruption of capillary liquid bridge 76.

DV-substrate 70 may be proportioned substantially similar to substrate 12. Alternatively, DV-substrate 70 may be proportioned substantially similar to template 18. DV-substrate 70, however, may be proportioned different than substrate 12 and/or template 18 depending on design considerations.

Imprint head 30 (shown in FIG. 1) may be configured to position DV-substrate 70 above substrate 12. For example, imprint head 30 may be configured to position DV-substrate 70 above substrate approximately 20 mm. Alternatively, DV-substrate 70 may be positioned using a second imprint head and/or other apparatus. For simplicity, positioning using imprint head 30 is discussed herein; however, positioning is not limited to use of imprint head 30.

DV-substrate 70 and substrate 12 may vary a distance d_{KS}. Imprint head 30 may apply a force F to DV-substrate 70 such that surface 74 of DV-substrate 70 contacts at least one droplet 58 of polymerizable material 34 on substrate 12. Generally, a distance d_{NC} may exist between DV-substrate 70 and substrate 12 during contact of DV-substrate 70 with droplet 58. The magnitude of distance d_{NC} is such that it may reduce ancillary forces that may pull DV-substrate 70 and substrate 12 into direct contact. As such, DV-substrate 70 and substrate 12 may never be in direct contact. Additionally, distance d_{NC} may provide additional volume of droplet 58 to transfer to either DV-substrate 70 or substrate 12.

Contact between DV-substrate 70 and droplet 58 may form a capillary liquid bridge 76 between DV-substrate 70 and substrate 12. Capillary liquid bridge 76 may be disrupted as DV-substrate 70 and substrate 12 are separated by a separation force F_{S}. Separation force F_{S} may be provided by imprint head 30, chuck 14, chuck 28, and/or the like. Disruption of the capillary liquid bridge 76 may cause droplet 58 to separate into RV droplets 58a and 58b. RV droplets 58a and 58b generally have reduced volumes as compared to droplet 58.

Contact angle of DV-substrate 70 to droplet 58 may additionally alter volume of RV droplets 58a and 58b. For example, when contact angle of DV-substrate 70 to droplet 58 is substantially similar, volume division of droplet 58 to RV droplets 58a and 58b may be substantially equal. As contact angle of DV-substrate 70 to droplet 58 increases or decreases, the type of material of DV-substrate 70 and/or substrate 12 may determine the volume of RV droplets 58a and/or 58b attaching to DV-substrate 70 and substrate 12, respectively. For example, if the contact angle of polymerizable material 34 on DV-substrate 70 is approximately 100 degrees and the contact angle of polymerizable material 34 on substrate 12 is approximately 20 degrees, then at least approximately half of the volume of droplet 58, if not more, may reside on substrate 12. In a similar fashion, if the contact angle of polymerizable material 34 on DV-substrate 70 is approximately 20 degrees, and the contact angle of polymerizable material 34 on substrate 12 is approximately 100 degrees, then at least approximately half of the volume of droplet 58, if not more, may reside on DV-substrate 70.

Furthermore, by selecting varying surface energies between the DV-substrate 70 and substrate 12, the capillary liquid bridge 76 may be biased. For example, if the surface energy of DV-substrate 70 is approximately 40 to 50 mN/m and the substrate 12 is approximately 18 to 20 mN/m, then at least approximately half of the volume of droplet 58, if not more, may reside on DV-substrate 70.

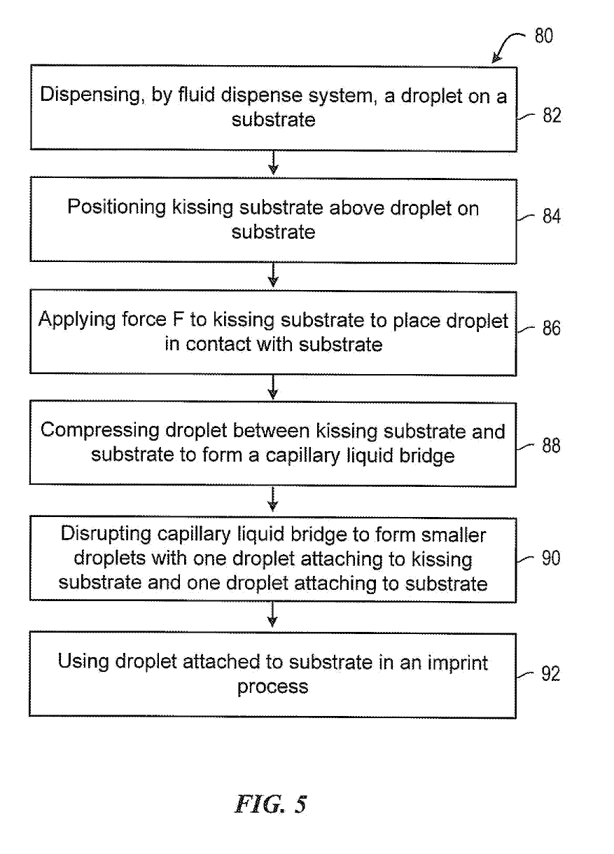

FIG. 5 illustrates an exemplary method 80 for controlling volume of droplet 58 on substrate 12. In a step 82, fluid dispense system 32 may dispense droplet 58 on substrate 12. Typically, drop patterns may be designed such that droplet 58 may not merge and/or substantially interfere with other droplets on substrate 12 (i.e., substantially individually isolated). In a step 84, DV-substrate 70 may be positioned above droplet 58 on substrate 12. In a step 86, force F may be applied to DV-substrate 70 such that DV-substrate 70 contacts droplet 58 on substrate 12. In a step 88, droplet 58 may be compressed between DV-substrate 70 and substrate 12 forming a capillary liquid bridge 76. In a step 90, the capillary liquid bridge 76 may be disrupted to form RV droplets 58a and 58b from droplet 58. RV droplet 58a may attach to DV-substrate 70 and RV droplet 58b may attach to substrate 12. RV droplets 58a and 58b may have reduced volumes as compared to droplet 58. In a step 92,. RV droplet 58b on substrate 12 and/or RV droplet 58a on DV-substrate 70 may be used for imprinting as illustrated and described in relation to FIGS. 1 and 2.

What is claimed is:

1. A method for controlling volume of a plurality of droplets, comprising:
dispensing the droplets in a drop pattern on a first substrate;
positioning a second substrate in superimposition with the drop pattern on the first substrate;
applying a first force to the second substrate, the first force positioning the second substrate in contact with at least one droplet on the first substrate forming a capillary liquid bride between the first substrate and the second substrate; and,
applying a second force to the second substrate, the second force substantially disrupting the capillary liquid bridge to form from the droplet at least one reduced volume droplet on the first substrate and at least one reduced volume droplet on the second substrate, wherein the reduced volume droplet on the first substrate has a first volume, and the reduced volume droplet of the second substrate has a second volume.

2. The method of claim 1, wherein the first volume is greater than the second volume.

3. The method of claim 1, wherein the first volume is substantially similar to the second volume.

4. The method of claim 1, wherein the first volume is less than the second volume.

5. The method of claim 1, wherein application of the first force to the second substrate positions the second substrate at a first distance from the first substrate, the first distance determined to reduce ancillary forces.

6. The method of claim 5, wherein the first distance is determined such that the first volume is greater than the second volume.

7. The method of claim 1, wherein a contact angle of the second substrate is selected to be substantially similar to a contact angle of the first substrate.

8. The method of claim 1, wherein a contact angle of the second substrate is selected to be greater than a contact angle of the first substrate.

9. The method of claim 1, wherein a contact angle of the second substrate is selected to be less than a contact angle of the first substrate.

10. The method of claim 1, wherein a surface energy of the second substrate is selected to be greater than a surface energy of the first substrate.

11. The method of claim 1, wherein a surface energy of the second substrate is selected to be less than a surface energy of the first substrate.

12. The method of claim 1, wherein the droplet includes polymerizable material.

13. The method of claim 1, wherein the droplet includes biomaterial.

14. The method of claim 1, wherein the droplet includes solar cell material.

15. The method of claim 1, wherein droplets are dispensed on the first substrate using a fluid dispense system having a plurality of tips, wherein the distance between each tip and the first substrate is selected to minimize gas in droplets.

16. The method of claim 1, wherein application of the first force to the second substrate compresses the droplet between the first substrate and the second substrate without direct contact between the first substrate and the second substrate.

17. The method of claim 1, wherein the second substrate is formed of substantially hydrophobic material.

18. The method of claim 1, further comprising:
positioning an imprint lithography template in superimposition with the first substrate;
contacting the imprint lithography template to the first reduced volume droplet;
solidifying the first reduced volume droplet forming at least a portion of a patterned layer; and,
separating the imprint lithography template and the patterned layer.

19. A method of reducing droplet volume on a first substrate, comprising:
positioning a droplet on the first substrate, the droplet having a first volume;
positioning a second substrate in superimposition with the first substrate;
contacting the second substrate to the droplet, the second substrate and the first substrate separated by a first distance; and,
separating the second substrate from the droplet forming a first reduced volume droplet on the substrate, the first reduced volume droplet having a droplet volume less than the first volume.

20. A method of controlling volume of at least one droplet on a first substrate, comprising;
dispensing, by a fluid dispense system, a drop pattern on a substrate, the drop pattern having at least one droplet with a droplet volume;
positioning a second substrate at a distance from the first substrate, the second substrate contacting the droplet forming a capillary liquid bridge;
separating the second substrate from the droplet to substantially disrupt the capillary liquid bridge with at least a portion of the droplet volume being transferred to the DV-substrate.
